(19) United States
(12) Patent Application Publication
(10) Pub. No.: US 2009/0039617 A1
(43) Pub. Date: Feb. 12, 2009

(54) Apparatus for connecting one of a chain, strap and cable attached to an object to be one of towed and dragged to a tow hitch attached to a towing vehicle

(76) Inventor: Joseph M. Klyeman, York, PA (US)

Correspondence Address: JAMES RAY & ASSOCIATES, 2640 PITCAIRN ROAD, MONROEVILLE, PA, 15146, US

(21) Appl. No.: 12/221,287

(22) Filed: Aug. 1, 2008

Related U.S. Application Data
(60) Provisional application No. 60/954,447, filed on Aug. 7, 2007.

(51) Int. Cl. B60D 1/18

(52) U.S. Cl. 280/504

(57) ABSTRACT

An apparatus for connecting a chain, strap or cable attached to a pre-selected object to be towed to a tow hitch attached to a towing vehicle. The apparatus includes a plate member having a first predetermined shape. An aperture, having a second predetermined shape, which is at least sufficient to enable passing a ball of such hitch therethrough, is formed generally centrally through the plate member. At least one elongated slot, having each of a third predetermined shape and a predetermined width over at least a portion thereof to receive a base of such hitch therein, is formed through the plate member. The at least one elongated slot being in open communication with the aperture and extends outwardly therefrom. Finally, a connecting mechanism engages both the plate member and one of such chain, strap and cable for connecting such towing vehicle to such pre-selected object to be one of dragged and towed.

### CROSS REFERENCE TO RELATED APPLICATION

This patent application is related to and claims priority from U.S. Provisional Patent Application Ser. No. 60/954,447 filed Aug. 7, 2007.

### FIELD OF THE INVENTION

The present invention relates, in general, to towing vehicles and, more particularly, this invention relates to an apparatus for use in connecting at least one of a chain, strap, and cable that is attached to a pre-selected object to be one of towed and dragged to a hitch connected to a towing vehicle.

### BACKGROUND OF THE INVENTION

Prior to the conception and development of the present invention, as is generally well known in the prior art, it is oftentimes necessary to tow a vehicle and/or trailer from many different reasons. Such reasons include but are certainly not limited to inoperability of the vehicle to be towed. Such vehicle could become stuck in mud and/or snow and not be able to free itself.

Additionally, it is well recognized that when forests are being logged it is necessary to drag the fallen trees to an area for loading onto vehicles which will transport them to a saw mill.

Examples of prior art type equipment used in towing can be found in U.S. Pat. Nos. 5,158,316 and 5,566,965.

### SUMMARY OF THE INVENTION

The present invention, according to a first embodiment, provides an apparatus for connecting one of a chain, strap and cable that has been attached to an object such as, for example, a log to be dragged to a loading area, and one of a vehicle and a trailer to be towed, to a tow hitch that is attached to a towing vehicle. The apparatus includes a plate member having a first predetermined shape. An aperture, having a second predetermined shape, which is at least sufficient to enable passing a ball of such hitch therethrough, is formed generally centrally through the plate member. At least one elongated slot, having each of a third predetermined shape and a predetermined width over at least a portion thereof to receive a base of such hitch therein, is formed through the plate member. The at least one elongated slot being placed such that it is in open communication with the aperture and so that it extends outwardly therefrom. There is a connecting means which is engageable with the plate member and such one of such chain, strap and cable for connecting such towing vehicle to such one of such vehicle and such trailer.

According to a second embodiment of the invention, the connecting means engageable with the plate member and such one of such chain, strap and cable for connecting such towing vehicle to such one of such vehicle and such trailer used in the first embodiment is a second elongated slot formed through the plate member. The second elongated slot has each of the third predetermined shape and a second predetermined width. The second predetermined width is narrower than the first predetermined width over at least a portion thereof to receive such one of such chain, strap and cable therein. The second elongated slot is positioned in open communication with the aperture and extends outwardly therefrom. Such second elongated slot enables connecting such towing vehicle to such one of such vehicle and such trailer.

Finally, according to a third embodiment of the invention, the connecting means engageable with the plate member and such one of such chain, strap and cable for connecting such towing vehicle to such one of such vehicle and such trailer, used in the first embodiment, is a hook means connected to the plate member opposite the at least one elongated slot and engaged by such one of such chain, strap and cable for connecting such towing vehicle to such one of such vehicle and such trailer.

### OBJECTS OF THE INVENTION

It is, therefore, one of the primary objects of the present invention to provide an apparatus for connecting one of a chain, strap and cable attached to a pre-selected object to be one of dragged and towed to a tow hitch attached to a towing vehicle which is easy to use.

Another object of the present invention is to provide an apparatus for connecting one of a chain, strap and cable attached to a pre-selected object to be one of dragged and towed to a tow hitch attached to a towing vehicle which is relatively inexpensive to produce.

Still another object of the present invention is to provide an apparatus for connecting one of a chain, strap and cable attached to a pre-selected object to be one of dragged and towed to a tow hitch attached to a towing vehicle which will substantially minimize damage to a vehicle or trailer being towed as well as to the hitch on the towing vehicle.

Yet another object of the present invention is to provide an apparatus for connecting one of a chain, strap and cable attached to a pre-selected object to be one of dragged and towed to a tow hitch attached to a towing vehicle which requires less time to hitch up.

An additional object of the present invention is to provide an apparatus for connecting one of a chain, strap and cable attached to a pre-selected object to be one of dragged and towed to a tow hitch attached to a towing vehicle which is generally much more stable to use than prior art type devices.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a perspective view of one embodiment of the invention;

FIG. 2 is a perspective view of a second embodiment of the invention; and

FIG. 3 is a perspective view of still another embodiment of the invention illustrating how each of the embodiments engage a hitch.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing Figures.

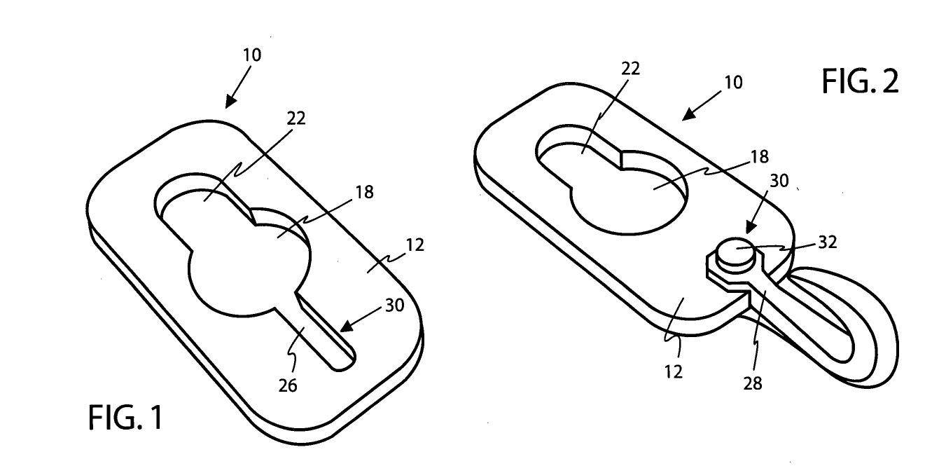

Reference is now made, more particularly, to drawing FIGS. 1-3. Illustrated therein is an apparatus, generally designated 10, for connecting at least one of a chain 14, strap (not shown) and a cable (not shown) that is attached to a pre-selected object (not shown) to be one of dragged and towed to a tow hitch, generally designated 20, attached to a towing vehicle (not shown).

The apparatus 10, according to a first embodiment of the instant invention, includes a plate member 12 having a first predetermined shape and formed from a predetermined material having sufficient strength for pulling the weight of the vehicle or trailer to be towed. There is an aperture 18, having a second predetermined shape, which is at least sufficient to enable passing a ball portion 16 of such hitch 20 therethrough, formed generally centrally through the plate member 12.

Such first predetermined shape of the plate member 12 is selected from one of a generally rectangular and a generally oblong shape. The most presently preferred first predetermined shape of the plate member 12 is generally rectangular.

At least one elongated slot 22, having each of a third predetermined shape and a predetermined width over at least a portion thereof to receive a base portion 24 of such hitch 20 therein, is formed through the plate member 12. The at least one elongated slot 22 is placed such that it is in open communication with the aperture 18 and extending outwardly therefrom. The presently preferred third predetermined shape of the elongated slot 22 is generally U-shaped.

Such second predetermined shape of the aperture 18 is selected from one of a generally circular and a generally hexagonal shape. The most presently preferred second predetermined shape of the aperture 18 is generally circular.

There is also a connecting means, generally designated 30, engageable with the plate member 12 and such one of such chain, strap and cable for connecting such towing vehicle to such pre-selected object to be one of dragged and towed.

In the embodiment of the invention illustrated in FIG. 1 the connecting means 30 is engageable with the plate member 12 and such chain 16 by a second elongated slot 26. Elongated slot 26 includes each of the third predetermined shape described above and a second predetermined width, which is narrower than the first predetermined width over at least a portion thereof, to receive such one of such chain 16, such strap and such cable therein. Elongated slot 26 is formed through the plate member 12 and is positioned such that it to is in open communication with the aperture 18 and extends outwardly therefrom. Such second elongated slot 26 enables connecting such towing vehicle to such pre-selected object to be one of dragged and towed.

In the embodiment of the invention illustrated in FIG. 2 the connecting means 30 is engageable with the plate member 12 and such chain 16 by a clevis 28 and bolt 32.

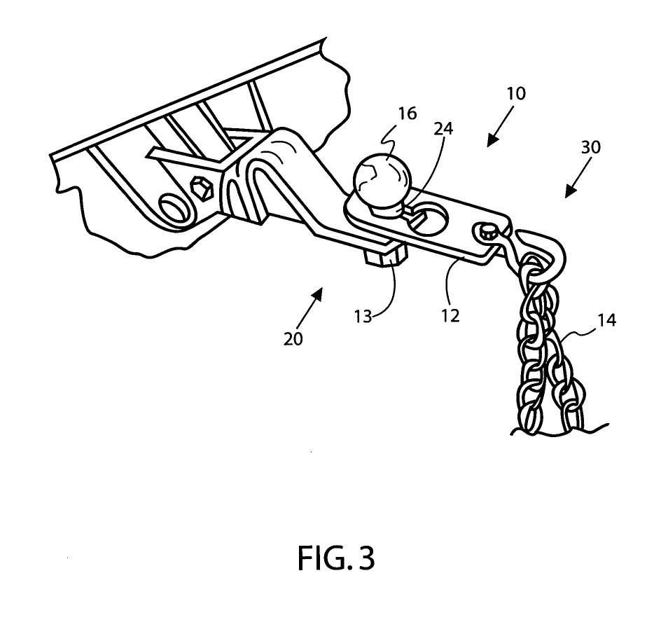

Finally, in the embodiment of the invention illustrated in FIG. 3 the connecting means 30 is engageable with the plate member 12 and such chain 16 by a hook means 34 connected to the plate member 12 opposite the at least one elongated slot 22 and engaged by such one of such chain 16, such strap and cable for connecting such towing vehicle to such pre-selected object to be one of dragged and towed.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

I claim:

1. An apparatus specifically designed for connecting one of a chain, strap and cable attached to a pre-selected object to be one of towed and dragged to a tow hitch attached to a towing vehicle, said apparatus comprising:
(a) a plate member having a first predetermined shape;
(b) an aperture, having a second predetermined shape which is at least sufficient to enable passing a ball of such hitch therethrough, formed generally centrally through said plate member;
(c) at least one elongated slot, having each of a third predetermined shape and a predetermined width over at least a portion thereof to receive a base of such hitch therein, formed through said plate member, said at least one elongated slot being in open communication with said aperture and extending outwardly therefrom; and
(d) a connecting means engageable with said plate member and such one of such chain, strap and cable for connecting such towing vehicle to such pre-selected object to be one of dragged and towed.

2. An apparatus, according to claim 1, wherein said first predetermined shape of said plate member is one of generally rectangular and generally oblong.

3. An apparatus, according to claim 2, wherein said first predetermined shape of said plate member is generally rectangular.

4. An apparatus, according to claim 1, wherein said second predetermined shape of said aperture is one of generally circular and generally hexagonal.

5. An apparatus, according to claim 4, wherein said second predetermined shape of said aperture is generally circular.

6. An apparatus, according to claim 1, wherein said third predetermined shape of said elongated slot is generally U-shaped.

7. An apparatus, according to claim 1, wherein said connecting means is engageable with said plate member and such chain.

8. An apparatus, according to claim 1, wherein said connecting means is a clevis.

9. An apparatus specifically designed for connecting one of a chain, strap and a cable attached to a pre-selected object be towed to a tow hitch attached to a towing vehicle, said apparatus comprising:
(a) a plate member having a first predetermined shape;
(b) an aperture, having a second predetermined shape which is at least sufficient to enable passing a ball of such hitch therethrough, formed generally centrally through said plate member;
(c) a first elongated slot, having each of a third predetermined shape and a first predetermined width over at least a portion thereof to receive a base of such hitch therein, formed through said plate member, said first elongated slot being in open communication with said aperture and extending outwardly therefrom; and
(d) a second elongated slot, having each of said third predetermined shape and a second predetermined width, which is narrower than said first predetermined width, over at least a portion thereof to receive such one of such chain, such strap and such cable therein, formed through said plate member, said second elongated slot being in open communication with said aperture and extending outwardly therefrom, said second elongated slot enabling connecting such towing vehicle to such pre-selected object to be one of dragged and towed.

10. An apparatus specifically designed for connecting one of a chain, strap and cable attached to a pre-selected object to be towed to a tow hitch attached to a towing vehicle, said apparatus comprising:
(a) a plate member having a first predetermined shape;
(b) an aperture, having a second predetermined shape which is at least sufficient to enable passing a ball of such hitch therethrough, formed generally centrally through said plate member;
(c) at least one elongated slot, having each of a third predetermined shape and a predetermined width over at least a portion thereof to receive a base of such hitch therein, formed through said plate member, said at least one elongated slot being in open communication with said aperture and extending outwardly therefrom; and
(d) a hook means connected to said plate member opposite said at least one elongated slot and engaged by such one of such chain, strap and cable for connecting such towing vehicle to such pre-selected object to be one of dragged and towed.

11. An apparatus, according to claim 10, wherein said hook means is connected to said plate member by a bolt.
